(19) United States
(12) Patent Application Publication
(10) Pub. No.: US 2015/0336338 A1
(43) Pub. Date: Nov. 26, 2015

(54) PROCESS FOR MANUFACTURING A FIBROUS MATERIAL PRE-IMPREGNATED WITH THERMOPLASTIC POLYMER

(71) Applicant: ARKEMA FRANCE, Colombes (FR)

(72) Inventors: Serge BORDERE, Jurancon (FR); Patrick DELPRAT, Lescar (FR); Patrice GAILLARD, Hagetaubin (FR); Oleksadr KORZHENKO, Pau (FR)

(73) Assignee: ARKEMA FRANCE, Colombes (FR)

(21) Appl. No.: 14/410,454

(22) PCT Filed: Jun. 17, 2013
(86) PCT No.: PCT/FR2013/051405

§ 371 Date: Dec. 22, 2014

(30) Foreign Application Priority Data
Jun. 22, 2012 (FR) 1255907

(51) Int. Cl. B29D 7/01; C08J 5/24; B29B 13/02

(52) U.S. Cl. CPC B29D 7/01; B29B 13/02; C08J 5/24; B29L 2007/008

(57) ABSTRACT

A process for manufacturing a pre-impregnated fibrous material, including a step of impregnation of said fibrous material with a matrix being of a thermoplastic polymer in the molten state. This process is characterized in that, prior to the impregnation step, an insertion step of incorporating, into said impregnating thermoplastic polymer, a lubricant including at least one oligomer chosen from oligomers of a cyclic ester, oligomers of a cyclic ether and oligomers of an organomineral compound. This oligomer makes it possible to lubricate the thermoplastic polymer, to promote wetting of the fibres of the fibrous material, and therefore to notably improve the impregnation of the fibrous material.

The present invention relates to a process for manufacturing a fibrous material pre-impregnated with thermoplastic polymer.

The term “fibrous material” is intended to mean fabrics, felts or nonwovens which are in the form of strips, sheets, braids, rovings or fragments. It comprises an assembly of one or more fibers. When the fibers are continuous, the assembly thereof constitutes fabrics. When the fibers are short, the assembly thereof constitutes a felt or a nonwoven.

The fibers which may be incorporated into the composition of the fibrous material are more especially carbon fibers, glass fibers, polymer-based fibers, or plant fibers, used alone or as a mixture.

Such pre-impregnated fibrous materials are in particular intended for the production of light composite materials for the manufacture of mechanical parts having a three-dimensional structure and possessing properties of good mechanical strength and good thermal resistance and which are capable of discharging electro-static charges, i.e. properties compatible with the manufacture of parts in the mechanical, aeronautical and nautical, and electronics field.

Pre-impregnated fibrous materials are also called composite materials. They comprise the fibrous material consisting of fibers, termed reinforcing fibers, and of a matrix consisting of the impregnating polymer. The first role of this matrix is to keep the reinforcing fibers in a compact shape and to give the final product the desired shape. Such a matrix serves, inter alia, to protect the reinforcing fibers against abrasion and an aggressive environment, to control the surface appearance and to disperse any charges between the fibers. The role of this matrix is important for the long-term strength of the composite material, in particular with regard to fatigue and creep.

It is known practice to use refractory fabrics pre-impregnated with a resin to produce a thermally insulating matrix in order to provide thermal protection of mechanical devices subjected to high temperatures, as may be the case in the aeronautical or motor vehicle field. Reference may be made to European patent No 0 398 787 which describes a thermal protection layer comprising a refractory fabric, said layer being intended to protect the cylindrical casing of a ramjet engine combustion chamber. Apart from the complexity of producing this thermal protection layer, the refractory fabric embedded in this layer only performs the function of a heat shield.

Recourse has also been made, for several years, to composite fibers to manufacture in particular various aeronautical or motor vehicle parts. These composite fibers, which are characterized by good thermomechanical strengths and good chemical resistances, consist of a filamentary reinforcement forming a frame which is intended to distribute the tensile, flexural or compressive strength strains, to confer, in some cases, chemical protection on the material and to give it its shape.

Reference may be made, for example, to patent application FR 2 918 081 which describes a process for impregnating continuous fibers with a composite polymeric matrix containing a thermoplastic polymer. In order to improve the impregnation of the reinforcing fibers, said document teaches the use of a plasticizer and dispersant of carbon nanotubes (CNTs) in said thermoplastic matrix, thereby modifying its glass transition temperature Tg.

The processes for manufacturing composite parts from these coated fibers comprise various techniques, such as, for example, contact molding, spray molding, autoclave drape forming or low-pressure molding.

One technique for producing hollow parts is that referred to as filament winding, which consists in impregnating dry fibers with a resin and then in winding them over a mandrel formed of frames and having a shape suited to the part to be manufactured. The part obtained by winding is subsequently cured by heating. Another technique, intended to produce sheets or shells, consists in impregnating fabrics with fibers and then in compressing them in a mold in order to consolidate the laminated composite obtained.

For the manufacture of a polymeric material comprising fibrous reinforcement, a sizing step is generally used, which consists in depositing a film of thermoplastic polymer on fibers. Thus, the process for manufacturing a pre-impregnated material described in document U.S. Pat. No. 4,541,884 comprises, as fiber-coating step, the continuous passing of fibers through a molten bath of thermoplastic polymer containing an organic solvent such as benzophenone, this solvent making it possible to adjust the viscosity of the molten mixture and to provide good coating of the fibers. The fibers pre-impregnated with polymers are then formed (for example, cut into strips and then placed under a press, for the production of structural parts, and then heated at a temperature above the melting point of the polymer in order to provide cohesion of the material and in particular adhesion of the polymer to the fibers.

Depending on the chemical nature of the polymer, the heating temperatures can rise to temperatures above 250° C., and even above 320° C., said temperatures being much higher than the boiling point of the solvent, leading to an abrupt departure of the solvent, causing defects in the part and therefore a lack of reproducibility of the process and also risks of explosion placing operators in danger.

In order to avoid the use of organic solvent, the applicant has found a solution described in patent application WO 2011/030052, which constitutes the closest prior art. This document describes a process for impregnating a fibrous material, comprising a first series of fibers, termed reinforcing fibers, with a thermoplastic polymer, consisting of a second series of fibers. The process consists in bringing the two series of fibers into contact, then in heating the fibers at a temperature above the melting point of the impregnating polymer. This process therefore requires that the fibrous material, comprising the first series of fibers, has a melting point Mp above the melting point of the impregnating polymer constituting the second series of fibers, so as not to be degraded during the heating.

Irrespective of the solutions used to date for impregnating the fibrous material, including with the solution described in the prior art consisting of patent application WO 2011/030052, the applicant has noticed that the impregnation of fibrous materials remains, to date, a step that is difficult to implement. This is because, if the fibers of the fibrous material (termed reinforcing fibers) are not correctly impregnated, they degrade when the composite material is formed by heating at a temperature which is high, and at least equal to the melting point of the thermoplastic matrix. As it happens, having poorly impregnated fibers creates a degradation thereof and this degradation subsequently leads to defects in the composite material.

The applicant has in particular noticed that, until now, the wetting of the fibers is only partial since the impregnating matrix does not spread correctly. In this case, the fibers have “bare” zones, i.e. zones where said fibers are not impregnated with the polymer. Said bare zones are weakened and degrade in response to heat, thereby creating defects in the final product. In other zones, drops of polymer form on the reinforcing fibers, these drops possibly being responsible for the creation of bubbles and creating other defects in the final composite material.

Furthermore, for pre-impregnated fibrous materials, forming is carried out at a heating temperature above the melting point Mp of the thermoplastic polymer of the impregnating matrix. In addition, when the polymers have a high melting point Mp, such as polyamides (PAs) and copolymers thereof, polycarbonates (PCs), poly(butylene terephthalate) (PBT), polyether imides (PEIs), polyphenylene sulfide (PPS), polyether ketone ketone (PEKK), polyether ether ketone (PEEK) or poly(methyl methacrylate) (PMMA), there is then a high risk of degradation of the thermoplastic matrix, and that the fibrous matrix is not correctly impregnated and degraded during the forming thereof. However, it may be important, for certain structural parts which have to withstand high temperatures, and in order to produce parts of very complex geometry, to use impregnating polymers which have high melting points.

The aim of the invention is therefore to remedy at least one of the drawbacks of the prior art and more particularly to solve this problem. In order to solve this problem, it is proposed to lower the temperature for forming of the composite material formed by the fibrous material impregnated with the thermoplastic polymer matrix. Lowering the forming temperature thus makes it possible to limit the risks of thermal degradation of the thermoplastic matrix and of having a poor impregnation of the fibrous material.

The solution proposed by the present invention satisfies all these criteria and is easy to use in the manufacture of complex three-dimensional structures such as, in particular, aircraft wings, the fuselage of an aircraft, the hull of a boat, side frames or spoilers of a motor vehicle, or else brake disks, a cylinder body or steering wheels, or in protective shells for electronic elements or, finally, in parts of equipment designed for sport.

To this effect, the subject of the invention is a process for manufacturing a pre-impregnated fibrous material, comprising a step of impregnation of said fibrous material with a matrix consisting of a thermoplastic polymer in the molten state, characterized in that, prior to the impregnation step, an insertion step consists in incorporating, into said impregnating thermoplastic polymer, a lubricant comprising at least one oligomer or a mixture of oligomers, chosen from oligomers of a cyclic ester, oligomers of a cyclic ether and oligomers of an organomineral compound.

Thus, the oligomer, or the mixture of oligomers, introduced into the impregnating thermoplastic polymer in the molten state makes it possible to lubricate the latter. Since the thermoplastic polymer is lubricated, it becomes possible to transform it, or to form it, at a temperature below the transformation temperature thus far used for the forming. Another advantage of the use of such an oligomer as a lubricant lies in the fact that it makes it possible to promote wetting of the fibers of the fibrous material. Indeed, the wetting of the reinforcing fibers becomes complete, i.e. the impregnating matrix spreads completely over the reinforcing fibers and is distributed uniformly on the fibers of the fibrous matrix, so that said fibers are not degraded during heating.

The use of the oligomer, or of the mixture of oligomers, in a low content in the thermoplastic polymer therefore makes it possible to lubricate the thermoplastic polymer, to notably reduce the temperature for forming the polymer and to avoid any risk of degradation of its structure and of its final performance levels. It also makes it possible to notably improve the capacity to impregnate the fibers in the molten state, without organic solvents. As a result, the impregnation is greatly facilitated and makes it possible to obtain good results irrespective of the impregnation method used. By virtue of these two combined advantages, the performance levels of the fibers of the fibrous material are no longer degraded during the forming of the composite material. Furthermore, by virtue of the effect of decreasing the forming temperature, the present invention allows a reduction in energy consumption in said forming.

The invention also relates to a pre-impregnated composite material comprising reinforcing fibers coated in a thermoplastic polymer matrix, characterized in that the thermoplastic polymer matrix comprises a lubricant comprising at least one oligomer, or a mixture of oligomers, chosen from oligomers of a cyclic ester, oligomers of a cyclic ether and oligomers of an organomineral compound.

Polymer Matrix:

Regarding the thermoplastic polymers which go to constitute the matrix for impregnating the fibrous material, they can be chosen, without limitation, from:
polyethyleneimines (PEIs);
polyimides (PIs);
polyolefins, such as polyethylene, in particular high-density polyethylene, polypropylene and copolymers of ethylene and/or of polypropylene;
thermoplastic polyurethanes (TPUs);
polyesters, such as polyhydroxyalkanoates;
poly(methyl methacrylate) (PMMA);
polycarbonates (PCs);
polyethylene terephthalates (PETs) or polybutylene terephthalates (PBTs);
polyphenylene sulfides (PPSs);
polyvinyl chlorides;
silicone or fluorosilicone polymers;
poly(vinyl alcohol)s;
polyaryl ether ketones (PAEKs), such as polyether ether ketone (PEEK) and polyether ketone ketone (PEKK);
polyamides, such as polyamide 6 (PA-6), polyamide 11 (PA-11), polyamide 12 (PA-12), polyamide 6.6 (PA-6.6), polyamide 4.6 (PA-4.6), polyamide 6.10 (PA-6.10), polyamide 6.12 (PA-6.12), aromatic polyamides, in particular polyphthalamides and aramid, and block copolymers, in particular polyamide/polyether;
fluoropolymers comprising at least one monomer of formula (I):

CFX═CHX′ (I)

wherein X and X′ independently denote a hydrogen or halogen (in particular fluorine or chlorine) atom or a perhalogenated (in particular perfluorinated) alkyl radical, and preferably X═F and X′═H, such as poly(vinylidene fluoride) (PVDF), preferably in a form, copolymers of vinylidene fluoride with for example hexafluoropropylene (HFP), fluoroethylene/propylene (FEP) copolymers, copolymers of ethylene with either fluoroethylene/propylene (FEP) or tetrafluoroethylene (TFE) or perfluoromethyl vinyl ether (PMVE) or chlorotrifluoroethylene (CTFE), some of these polymers being in particular sold by the company Arkema under the name Kynar®;
phenoxy polymers (or resins), and
mixtures thereof;

and preferably from thermoplastic polymers with a high melting point Mp, namely starting from 130° C. and above, for instance polyamides (PAs) and copolymers thereof, poly(methyl methacrylate) (PMMA) and copolymers thereof, polycarbonates (PCs), polyethylene terephthalates (PETs), poly(butylene terephthalate) (PBT), polyether imides (PEIs), polyphenylene sulfide (PPS), polyether ketone ketone (PEKK), polyether ether ketone (PEEK), fluoropolymers, for instance poly(vinylidene fluoride) (PVDF) or hexafluoropropylene (HFP), fluoroethylene/propylene (FEP) copolymers, copolymers of ethylene with either fluoroethylene/propylene (FEP) or tetrafluoroethylene (TFE) or perfluoromethyl vinyl ether (PMVE) or chlorotrifluoroethylene (CTFE).

The phenoxy polymers (or resins) are polyhydroxyethers with alpha-glycol end groups. They result from the reaction between bisphenol A and epichlorohydrin; their weight-average molecular weight is from 25 000 to 60 000. They are compatible with thermosetting resins of the epoxy resin type.

For the fluoropolymers, use is preferably made of a vinylidene fluoride homopolymer (VDF of formula CH₂═CF₂) or a VDF copolymer comprising at least 50% by weight of VDF and at least one other monomer which is copolymerizable with VDF. The VDF content must be greater than 80% by weight, or even better still 90% by weight, in order to provide the structural part with good mechanical strength, especially when it is subjected to heat stresses. The comonomer may be a fluorinated monomer chosen, for example, from vinyl fluoride; trifluoroethylene (VF3); chlorotrifluoroethylene (CTFE); 1,2-difluoroethylene; tetrafluoroethylene (TFE); ethylene tetrafluoroethylene (ETFE), hexafluoropropylene (HFP); perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); and perfluoro(2,2-dimethyl-1,3-dioxole) (PDD). Preferably, the optional comonomer is chosen from chlorotrifluoroethylene (CTFE), hexafluoropropylene (HFP), trifluoroethylene (VF3) and tetrafluoroethylene (TFE). The comonomer may also be an olefin such as ethylene or propylene. The preferred comonomer is HFP.

For structural parts which must withstand high temperatures, in addition to the fluoropolymers, PAEKs (polyaryl ether ketones), such as PEK, PEEK, PEKK, PEKEKK, etc., are advantageously used according to the invention.

Compared with the processes of the prior art, the process according to the present invention is perfectly suitable for polymers with high melting points, and more particularly melting points above 130° C., as previously mentioned, for instance PMMA, polyamides (PAs), polycarbonates (PCs), fluoropolymers, PAEKs, high-density polyethylenes, or else PET or PBT.

Advantageously, the thermoplastic polymer which constitutes the impregnating matrix comprises at least one oligomer, or a mixture of oligomers, chosen from oligomers of a cyclic ester, oligomers of a cyclic ether and oligomers of an organomineral compound. This oligomer, or this mixture of oligomers, acts as a lubricant in the thermoplastic polymer matrix. This lubricant does not in any way modify the structure of the polymer into which it is incorporated, contrary to plasticizers. The glass transition temperature Tg and the melting point Mp of the thermoplastic polymer matrix are not therefore affected by the presence of the oligomer, or of the mixture of oligomers, and remain unchanged.

For the purposes of the invention, an “oligomer” is a polymer compound of small size, comprising between 2 and 30 monomers, i.e. the degree of polymerization of which is between 2 and 30.

When the oligomer, or the mixture of oligomers, is chosen from oligomers of a cyclic ester, it is more particularly chosen from:
oligomers of a polyester, such as cyclized poly(butylene terephthalate) (PBT), or mixtures containing same, such as the CBT 100 resin sold by Cyclics Corporation, for example,
lactides, or mixtures containing same,
cyclic oligomers of a lactone, for instance the dimer of ε-caprolactone, or mixtures containing same,
carbonate oligomers, and more particularly oligomers of alkylene carbonate, such as ethylene carbonate, propylene carbonate or butylene carbonate,
and mixtures thereof.

Lactides are cyclic dimers comprising two functional ester groups and are obtained by esterification of lactic acid. Lactides exist as three stereoisomers. When they polymerize above the degree of polymerization equal to 2, they polymerize by ring opening so as to create a lactic acid oligomer or polymer depending on the degree of polymerization.

A lactone is a monomer obtained by esterification and intramolecular cyclization of hydroxy acid. Cyclic dimers or trimers exist, such as the dimer of ε-caprolactone. Above this degree of polymerization, the oligomerization involves opening of its ring.

When the oligomer, or the mixture of oligomers, is chosen from oligomers of a cyclic ether, it is more particularly chosen from:
ethylene glycol oligomers,
propylene glycol oligomers, and
mixtures thereof.

The oligomers of a cyclic ether, also called polyolefin ether or polyether, are produced from ethylene glycol or propylene glycol. Their oligomerization involves opening of their ring. These oligomers are particularly suitable for impregnating natural fibers, such as flax, silk, in particular spider silk, hemp or sisal fibers.

When the oligomer, or the mixture of oligomers, is chosen from oligomers of an organomineral compound, it is more particularly chosen from:
silane oligomers,
siloxane oligomers, and
mixtures thereof.

The silane oligomers, of formula (R₂Si)ₙ with n being between 2 and 30, are oligomers which may be cyclic or linear.

These silane or siloxane oligomers are particularly suitable for impregnating mineral fibers, such as glass, boron, silica or carbon fibers.

Be that as it may, the oligomer, or the mixture of oligomers, used must always have a melting point Mp below or equal to the melting point Mp of the impregnating thermoplastic matrix and a viscosity below that of the impregnating thermoplastic matrix, so that the oligomer can correctly and uniformly mix in the molten thermoplastic matrix.

The oligomers used can be produced from a cyclized component, such as cyclic esters, cyclic ethers or siloxanes, for example. On the other hand, in this case, the oligomers are not necessarily cyclic and can be linear.

Advantageously, when the oligomers used are cyclic, they have a totally crystalline structure, i.e. their molecules are ordered according to an organized and compact arrangement. Such a crystalline structure has great fluidity in the molten state, thereby making it possible to further increase the lubrication of the thermoplastic matrix in the molten state. Thus, the CBT 100 resin, the oligomer of polycarbonate and certain silane oligomers are 100% crystalline.

The oligomer, or the mixture of oligomers, acting as a lubricant in the thermoplastic matrix is incorporated into this impregnating thermoplastic matrix in proportions of between 0.1% and 30% by weight, preferably between 0.2% and 10% by weight, preferably less than 10% and greater than or equal to 0.2% and preferably from 0.2% to 5%.

If the lubricant is not incorporated in sufficient amount, it does not then make it possible to correctly lubricate the thermoplastic polymer of the matrix. On the other hand, above a certain amount, the polymer matrix is saturated. When the amount of oligomer is too great, phase separation can even occur in the polymer. Consequently, the upper limit, i.e. the critical threshold not to be exceeded, with regard to the proportions of oligomer, should be less than the amount which causes this phase separation. Thus, in the particular case of cyclized polybutylene terephthalate) or of the CBT 100 resin, for example, the proportions of oligomer in the polymer matrix are preferably less than 15% by weight, and even more preferably they are between 0.5% and 5% by weight, which is sufficient to obtain the expected lubrication and the preservation of the physical (mechanical) properties of the thermoplastic polymer matrix and of the interface with the impregnated fibrous material.

The incorporation of the oligomer, or of the mixture of oligomers, in these proportions does not affect the glass transition temperature Tg nor the melting point Mp of the thermoplastic polymer, which remain unchanged. The presence of the oligomer makes it possible, on the other hand, to decrease the transformation temperature, also known as forming temperature, of the impregnated fibrous material.

Indeed, the forming temperature must always be above the melting point Mp of the polymer matrix. This is because, when a polymer matrix having a high melting point Mp is used, the forming temperature, or transformation temperature, which is above the melting point Mp, can degrade the thermoplastic polymer matrix. Table I below makes it possible to demonstrate that the forming temperature of the composite material can be reduced by virtue of the presence of the oligomer, or of the mixture of oligomers, in the polymer matrix.

TABLE I

| | Forming T° | | Forming T° |
|---|---|---|---|
| | without | | with |
| Polymer matrix | CBT 100 | % CBT | CBT 100 |
| Extrusion grade polycarbonate | 300° C. | 0.20% | 280° C. |
| Extrusion grade polycarbonate | 300° C. | 2.00% | 260° C. |
| Polyamide 6 | 290° C. | 0.50% | 280° C. |
| PBT | 310° C. | 1.00% | 290° C. |
| PEEK | 380° C. | 1.00% | 360° C. |
| Charged PEI | 350° C. | 2.00% | 330° C. |

Thus, when the polymer matrix is made of polycarbonate for example, its forming temperature is 300° C. If the CBT 100 resin is added to the matrix, the forming temperature can be reduced to between 260 and 280° C. according to the proportions of CBT resin in the thermoplastic polymer matrix. Likewise, when the polymer matrix is made of polyether ether ketone (PEEK), the transformation temperature is 380° C. and is reduced to 360° C. when the CBT resin is added thereto in an amount of 1% by weight in the matrix.

It will be noted here that cyclized poly(butylene terephthalate) and mixtures containing same, such as the CBT 100 resin sold by Cyclics Corporation, are admittedly known and used as plasticizers in polymer matrices. Reference may, moreover, be made to document WO 2010/046606 filed by the applicant, which uses such a plasticizer in a polymer matrix for increasing its flexibility, reducing its glass transition temperature Tg, and increasing its malleability and/or its extensibility. The use of the plasticizer also makes it possible to produce composite materials containing a high load of carbon nanotubes CNTs for example. Likewise, document WO 2010/072975 describes the use of polyether ketone ketone (PEKK) fibers in which carbon nanotubes are dispersed through the use of a dispersant which can be chosen from plasticizers, such as cyclized poly(butylene terephthalate) and mixtures containing same, such as the CBT 100 resin.

In the case of the present invention, it involves a process for manufacturing a pre-impregnated fibrous material in which the cyclized poly(butylene terephthalate) and mixtures containing same, and more generally the oligomers previously mentioned, are used in a low content, i.e. in a proportion which makes it possible not to cause phase separation in the thermoplastic polymer matrix. Indeed, the upper limit, i.e. the critical threshold not to be exceeded, with regard to the proportions of oligomer, must be below the threshold value above which this produces phase separation in the matrix. This choice makes it possible to obtain a lubricant which provides a notable decrease in the forming temperature of the polymer without changing its physical properties and in particular without reducing its glass transition temperature Tg.

Insertion Step

The insertion of the oligomer, or of the mixture of oligomers, into the thermoplastic polymer is advantageously carried out via the molten route, either by kneading or by extrusion. The oligomer is incorporated into the molten thermoplastic matrix. The oligomer does not need to be melted before being incorporated since it has a melting point below that of the thermoplastic matrix. It therefore melts when it comes into contact with the thermoplastic matrix. The thermoplastic matrix in the molten state and also the oligomer, or the mixture of oligomers, are introduced into a high-shear device in order to be mixed. Such a device is, for example, an extruder with twin co-rotating screws or a co-kneader comprising a rotor which has fins suitable for engaging with teeth mounted on a stator. The mixture is recovered after transformation of the molten material in the form of a strip for example.

Examples of co-kneaders that can be used according to the invention are the Buss® MDK 46 co-kneaders and those of the Buss® MKS or MX series, sold by the company Buss AG, which all consist of a screw shaft which has fins, placed in a heating barrel optionally consisting of several parts and the internal wall of which has kneading teeth suitable for engaging with the fins so as to produce shearing of the kneaded material. The shaft is rotated and given an oscillating movement in the axial direction by a motor.

This kneading or extrusion operation is carried out at a temperature which causes softening or melting of the thermoplastic and therefore of the oligomer, the melting point of which is lower.

The thermoplastic polymer containing the oligomer, or the mixture of oligomers, can then be used for the step of impregnating the fibrous material.

However, before this impregnation step, an additive can also be added so as to make it possible to further improve the lubrication of the polymer matrix. According to another characteristic of the invention, this additive advantageously consists of fillers, such as electricity-conducting or heat-conducting particles.

The fillers used as additive according to the invention are, for example, metal powder, or nanofillers of carbon origin, or silicon carbide, boron carbonitride, boron nitride or silicon nitride nanotubes. Preferably, nanofillers of carbon origin are used, for instance carbon nanotubes, carbon nanofibers, carbon black, or graphenes, fibrils, graphites, or a mixture thereof in any proportions. These nanofillers are in powder form and can be introduced into the impregnating thermoplastic matrix.

Carbon nanotubes are preferably used. It is recalled that, the term “carbon nanotubes CNTs” is intended to mean one or more hollow tubes having one or more graphite plane walls or graphene sheets, which are coaxial, or a graphene sheet wound up on itself. This or these tubes, which is (are) usually “open”, i.e. open at one end, resemble a number of coaxially disposed lattice tubes; in cross section, the CNTs take the form of concentric rings. The external diameter of the CNTs is from 2 to 50 nm. There are single-walled carbon nanotubes or SWNTs and multi-walled carbon nanotubes or MWNTs.

These conductive fillers are introduced as additive into the impregnating thermoplastic matrix in the following way: the mineral fillers in powder form are placed directly in the molten thermoplastic polymer, before or after the incorporation of the oligomer. The kneading or the extrusion then makes it possible to ensure uniform distribution of the fillers in the matrix.

Advantageously, CNTs are preferably used as additive since, in addition to the improvement in the lubrication, they also make it possible to dissipate the heat generated by the shearing caused during the forming of the composite material.

The carbon nanotubes are introduced into the impregnating thermoplastic matrix in proportions of between 1 and 100 ppm. These proportions correspond to a minimum weight percentage of about 0.01% relative to the weight of the thermoplastic matrix containing the oligomer.

Impregnation Step:

The fibers of the fibrous material can be impregnated in various ways. Indeed, by virtue of the presence of the oligomer in the impregnating thermoplastic matrix, the wetting of the fibers is considerably improved, and the thermoplastic is distributed around the fibers in much better fashion, so that it becomes possible to use any impregnation method without restriction.

Thus, a first impregnation method consists in passing the fibrous material through a molten bath of the impregnating thermoplastic matrix comprising the oligomer and optionally having had CNTs added thereto. The material then becomes impregnated with the mixture. The fibrous material is then cooled, and then it can be formed into the desired shape. When the fibrous substrates are in the form of a strip or, a sheet, they can be circulated in the bath of fluid polymer, for example liquid containing the CNT additive.

For the purposes of the invention, the term “fluid” is intended to mean a medium which flows under its own weight and which does not have a shape of its own (unlike a solid), such as a liquid which may be more or less viscous or a powder suspended in a gas (air for example), generally known under the term “fluidized bed”.

Another method, which is a continuous method, as described in patent application WO 2011/030052 consists in forming the thermoplastic matrix containing the oligomer, or the mixture of oligomers, optionally having had CNTs added thereto, in the form of fibers. This second series of fibers is brought into contact with the first series of fibers constituting the fibrous matrix, also called reinforcing fibers. The two series of fibers thus in contact are then heated, and then undergo one or more calenderings in order to be formed into a strip or sheets for example.

A third method consists in carrying out a direct plate-out by extrusion of a stream of the thermoplastic matrix-oligomer, optionally having had CNTs added thereto, on the fibrous matrix which is in the form of a sheet or strip or braid. One or more calenderings can also be carried out, between heating rolls, so as to obtain sheets or strips which have an excellent surface finish.

The impregnation of the fibrous substrate can also be carried out according to a fluidized-bed impregnation process, in which the polymeric composition, namely the thermoplastic matrix containing the oligomer, or the mixture of oligomers, and optionally having had CNTs added thereto, is in the form of a powder. The powder is suspended in a gas (air for example) and the fibrous material is circulated in this bath in a fluidized bed. This impregnation is carried out while maintaining the fluidized bed at a temperature at least equal to the melting point of the impregnating thermoplastic polymer. The fibrous material thus impregnated can then be dried.

The heating of the impregnating matrix can be carried out by means of infrared radiation, for example. It can also be carried out by induction or by microwave. The latter heating mode is particularly suitable in the presence of fillers such as carbon nanotubes CNTs, since this heating mode promotes heating to the core and makes it possible to obtain better distribution/dispersion of the CNTs within the material, resulting in better homogeneity of the physicochemical properties and, consequently, better properties overall on the final product.

The impregnation step is advantageously combined with forming of the composite material made of the fibrous material impregnated with the thermoplastic matrix. For this, the still hot material is placed in one or more successive forming devices and then, once formed, it is left to cool to ambient temperature.

The forming can, for example, be carried out by one or more successive calendering devices. The forming can also be carried out by extrusion so as to create profiled elements of slightly more complex shape. It can also be carried out by thermoforming so as to create three-dimensional parts of complex shape by means of a mold in which the softened material is placed. Such thermoformed parts are, for example, intended to form protective shells for electronic elements or complex parts of machines, or motor vehicle bodywork parts, etc.

Once the pre-impregnated composite material has been formed and cooled to ambient temperature, it is possible to subject it to annealing in order to stabilize its structure.

By virtue of the process which has just been described, it is possible to obtain a very well-impregnated fibrous material and to create three-dimensional parts of complex shape which exhibit no defect.

Fibrous Material:

The fibers constituting the fibrous material can be fibers of inorganic origin, such as carbon fibers or glass fibers, or else fibers of organic origin, such as fibers based on a thermoplastic or thermosetting polymer, or else fibers of plant origin. Kevlar fibers or aramid fibers can also be used. Each of these constituent fibers can be used alone or as a mixture.

The polymers which go to constitute the thermoplastic fibers are exemplified in the list given with regard to the polymer matrix described above.

The polymers which go to constitute the thermosetting fibers are chosen from: unsaturated polyesters, epoxy resins, vinyl esters, phenolic resins, polyurethanes, cyanoacrylates and polyimides, such as bismaleimide resins, aminoplasts (resulting from the reaction of an amine such as melamine with an aldehyde such as glyoxal or formaldehyde) and mixtures thereof.

The term “thermosetting polymers” or else “thermosetting resins” is intended to mean a material that is generally liquid at ambient temperature, or has a low melting point, which is capable of being cured, generally in the presence of a curing agent, under the effect of heat or a catalyst, or a combination of the two, so as to obtain a thermoset resin. The latter consists of a material containing polymer chains of varying length linked to one another via covalent bonds, so as to form a three-dimensional network. In terms of its properties, this thermoset resin is infusible and insoluble. It can be softened by heating it above its glass transition temperature (Tg), but, once it has been given a shape, it cannot be subsequently reshaped by heating.

The unsaturated polyesters result from the condensation polymerization of dicarboxylic acids containing an unsaturated compound (such as maleic anhydride or fumaric acid) and of glycols such as propylene glycol. They are generally cured by dilution in a reactive monomer, such as styrene, and then reaction of the latter with the unsaturations present on these polyesters, generally using peroxides or a catalyst, in the presence of heavy metal salts or of an amine, or else using a photoinitiator, an ionizing radiation, or a combination of these various techniques.

The vinyl esters comprise the products of reacting epoxides with (meth)acrylic acid. They can be cured after dissolution in styrene (in a manner similar to the polyester resins) or using organic peroxides.

The epoxy resins consist of materials containing one or more oxyrane groups, for example from 2 to 4 oxyrane groups, per molecule. In the case where they are polyfunctional, these resins can consist of linear polymers bearing epoxy end groups, or the backbone of which comprises epoxy groups, or else the backbone of which bears pendent epoxy groups. They generally require an acid anhydride or an amine as curing agent.

These epoxy resins can result from the reaction of epichlorohydrin with a bisphenol, such as bisphenol A. They may, as a variant, be alkyl glycidyl and/or alkenyl glycidyl ethers or esters; polyglycidyl ethers of mono- and polyphenols which are optionally substituted, in particular polyglycidyl ethers of bisphenol A; polyglycidyl ethers of polyols; polyglycidyl ethers of aliphatic or aromatic polycarboxylic acids; polyglycidyl esters of polycarboxylic acids; or polyglycidyl ethers of novolac. As a further variant, they may be products of the reaction of epichlorohydrin with aromatic amines, or glycidyl derivatives of aromatic mono- or diamines. Cycloaliphatic epoxides, and preferably diglycidyl ethers of bisphenol A (or DGEBA), F or A/F, can also be used in the present invention.

Among the curing agents or crosslinking agents, use may be made of products of functional diamine or triamine type, used at contents ranging from 1% to 5%.

For the temperatures for heating the thermosetting fibers, reference is made to melting points or softening temperatures; they are about from 50° C. to 80° C., typically 60° C.

After addition of a curing agent (or crosslinking agent), the melting point or softening temperature is then brought to between 100° C. and 150° C., typically 120° C.

The heating at the melting point Mp is combined with forming of the final composite material by means of a calendering, extrusion or thermoforming device, for example.

With regard to the inorganic fibers which can go to constitute the fibrous material, they are in particular carbon, glass, boron or silica fibers, natural fibers such as flax, silk, in particular spider silk, hemp or sisal. These fibers can be used pure, treated or else coated with a coating layer, for the purpose of facilitating the adhesion of/impregnation with the thermoplastic polymer matrix or their handling before impregnation by melting of this polymer.

Organic fibers can be mixed with the inorganic fibers so as to form the fibers of the fibrous material and which are intended to be impregnated with polymer after melting of the thermoplastic polymer matrix. In this case, organic fibers will of course be chosen, i.e. fibers of polymer of which the melting point is above the melting point Mp of the thermoplastic polymer matrix which is melted. Thus, there is no risk of melting for the constituent organic fibers of the fibrous material.

The fibrous material produced with the process is advantageously obtained with 50% of inorganic fibers and 50% of thermoplastic or thermosetting organic polymer fibers, preferably with 30% of inorganic fibers and 70% of thermoplastic or thermosetting organic polymer fibers.

1. A process for manufacturing a pre-impregnated fibrous material, comprising a step of impregnation of said fibrous material with a matrix consisting of a thermoplastic polymer in the molten state,
wherein, prior to the impregnation step, an insertion step consists of incorporating, into said impregnating thermoplastic polymer, a lubricant comprising at least one oligomer or a mixture of oligomers, chosen from oligomers of a cyclic ester, oligomers of a cyclic ether and oligomers of an organomineral compound.

2. The process for manufacturing a pre-impregnated fibrous material as claimed in claim 1, wherein said at least one oligomer is an oligomer of a cyclic ester and chosen from:
oligomers of a cyclic polyester, or mixtures containing same,
lactides,
cyclic oligomers of a lactone,
oligomers of alkylene carbonates chosen from ethylene carbonate, propylene carbonate or butylene carbonate, and
mixtures thereof.

3. The process for manufacturing a pre-impregnated fibrous material as claimed in claim 1, wherein said at least one oligomer is an oligomer of a cyclic ether and chosen from:
ethylene glycol oligomers,
propylene glycol oligomers, and
mixtures thereof.

4. The process for manufacturing a pre-impregnated fibrous material as claimed in claim 1, wherein said at least one oligomer is an oligomer of an organomineral compound and chosen from:
silane oligomers,
siloxane oligomers, and
mixtures thereof.

5. The process for manufacturing a pre-impregnated fibrous material as claimed in claim 1, wherein said at least one oligomer is introduced into said molten impregnating thermoplastic polymer in proportions below a threshold value above which phase separation occurs in said impregnating thermoplastic polymer.

6. The process for manufacturing a pre-impregnated fibrous material as claimed in claim 5, wherein said at least one oligomer is introduced into said molten impregnating thermoplastic polymer in proportions of between 0.1% and 30% by weight.

7. The process for manufacturing a pre-impregnated fibrous material as claimed in claim 1, wherein said at least one oligomer has a melting point Mp below or equal to that of said impregnating thermoplastic polymer and a viscosity below that of said impregnating thermoplastic polymer.

8. The process for manufacturing a pre-impregnated fibrous material as claimed in claim 1, wherein at the time of the insertion step, said impregnating thermoplastic polymer is heated to a temperature at least equal to its melting point, and said at least one oligomer is incorporated into said impregnating thermoplastic polymer by kneading or extrusion.

9. The process for manufacturing a pre-impregnated fibrous material as claimed in claim 1, wherein the impregnation step is carried out according to a method chosen from the following methods:
passing said fibrous material through a molten bath of said impregnating thermoplastic polymer,
deposit by extrusion of a stream of said impregnating thermoplastic polymer on said fibrous material,
impregnation by passing said fibrous material through a fluidized bed of particles of said impregnating thermoplastic polymer, or
bringing said impregnating thermoplastic polymer which is in the form of fibers into contact with the fibers of the fibrous material, then heating the assembly.

10. The process for manufacturing a pre-impregnated fibrous material as claimed in claim 1, wherein the thermoplastic polymers which constitute said impregnating thermoplastic polymer are chosen from:
polyethyleneimines (PEIs);
polyimides (PIs);
polyolefins,
thermoplastic polyurethanes (TPUs);
polyesters,
poly(methyl methacrylate) (PMMA);
polycarbonates (PCs);
polyethylene terephthalates (PETs) or polybutylene terephthalates (PBTs);
polyphenylene sulfides (PPSs);
polyvinyl chlorides;
silicone or fluorosilicone polymers;
poly(vinyl alcohol)s;
polyaryl ether ketones (PAEKs);
polyamides, and block copolymers, polyamide/polyether;
fluoropolymers comprising at least one monomer of formula (I):
CFX═CHX′ (I)
wherein X and X′ independently denote a hydrogen or halogen atom or a perhalogenated alkyl radical;
phenoxy polymers (or resins), and
mixtures thereof.

11. The process for manufacturing a pre-impregnated fibrous material as claimed in claim 1, wherein the impregnation step, consisting in heating said impregnating thermoplastic polymer to its melting point, is combined with forming of the composite material made up of said fibrous material and said impregnating thermoplastic polymer.

12. The process for manufacturing a pre-impregnated fibrous material as claimed in claim 1, wherein at the time of the step of insertion of said oligomer, there is also in the molten thermoplastic polymer an additive consisting of conductive mineral fillers in powder form, chosen from: metal powder, or silicon carbide, boron carbonitride, boron nitride or silicon nitride nanotubes, or nanofillers of carbon origin, chosen from carbon nanotubes, carbon nanofibers, carbon black, graphenes, fibrils, graphites, or a mixture thereof.

13. The process for manufacturing a pre-impregnated fibrous material as claimed in claim 12, wherein the conductive mineral fillers used as additive are carbon nanotubes.

14. The process for manufacturing a pre-impregnated fibrous material as claimed in claim 1, wherein said impregnating thermoplastic polymer is heated by means of infrared radiation, by induction or by microwave.

15. A pre-impregnated composite material comprising reinforcing fibers coated in a thermoplastic polymer matrix, wherein the said thermoplastic polymer matrix comprises a lubricant comprising at least one oligomer, or a mixture of oligomers, chosen from oligomers of a cyclic ester, oligomers of a cyclic ether and oligomers of an organomineral compound.

16. The process for manufacturing a pre-impregnated fibrous material as claimed in claim 1, wherein said thermoplastic is chosen from thermoplastic polymers with a high melting point Mp, starting from 130° C. and above, chosen from polyamides (PAs) and copolymers thereof, poly(methyl methacrylate) (PMMA) and copolymers thereof, polycarbonates (PCs), polyethylene terephthalates (PETs), poly(butylene terephthalate) (PBT), polyether imides (PEIs), polyphenylene sulfide (PPS), polyether ketone ketone (PEKK), polyether ether ketone (PEEK), fluoropolymers.

17. The process of manufacturing a pre-impregnated fibrous material, as claimed in claim 6, wherein said proportions are between 0.2 and 10% by weight.

18. The process according to claim 17, wherein said proportions are between 0.2 and 5% by weight.

19. The process according to claim 1, wherein said thermoplastic polymer has a melting point above 130° C. and is chosen from PMMA, polyamides, polycarbonates, fluoropolymers, PAEK, high density polyethylenes, PET or PBT.

20. The process according to claim 1, wherein said fibrous material is constituted from fibers chosen from: carbon, glass, boron or silica fibers or natural fibers from flax or silk.

21. The process according to claim 1, wherein said thermoplastic polymer is chosen from fluoropolymers and polyaryetherketones (PAEK).

22. The process according to claim 21, wherein said PAEK polymers are chosen from: PEK, PEEK, PEKK or PEKEKK.
